(19) United States
(12) Patent Application Publication
(10) Pub. No.: US 2025/0002342 A1
(43) Pub. Date: Jan. 2, 2025

(54) PROCESS OF OBTAINING A POWDER OF LITHIUM SULFIDE, AND USE THEREOF TO PREPARE A LPS COMPOUND

(71) Applicant: SPECIALTY OPERATIONS FRANCE, Lyon (FR)

(72) Inventors: Sébastien Jus, Paris (FR); Lauriane D'Alencon, Issy-Les-Moulineaux (FR); Thierry Le Mercier, Rosny-sous-Bois (FR)

(73) Assignee: SPECIALTY OPERATIONS FRANCE, Lyon (FR)

(21) Appl. No.: 18/576,678

(22) PCT Filed: Jul. 5, 2022
(86) PCT No.: PCT/EP2022/068495

§ 371 Date: Jan. 4, 2024

(30) Foreign Application Priority Data
Jul. 7, 2021 (EP) 21315122.8

(51) Int. Cl. C01B 17/22; C01B 25/14; C01D 15/02; H01M 10/0562

(52) U.S. Cl. CPC C01B 17/22; C01B 25/14; C01D 15/02; H01M 10/0562; C01P 2004/60; C01P 2006/12; C01P 2006/14; C01P 2006/40; H01M 2300/008

(57) ABSTRACT

The present disclosure relates to a process of obtaining a powder of lithium sulfide (Li2S powder) having a d50-value of less than 10 μm, a specific surface area of more than 5 m²/g, a total pore volume of more than 0.035 cm3/g and a percentage of total pore volume constituted of pore with diameter below 20 nm of more than 20%, comprising the steps of: a) providing a powder of lithium hydroxide having a d50-value of less than 10 μm and presenting a residual water content below 5 wt. % (LiOH powder A), and b) reacting such LiOH powder A with a sulfide reactant, in order to obtain the Li2S powder. The present disclosure also relates to the powder of lithium sulfide obtained from such process and the use of such Li2S powder to prepare a solid compound of formula (I): LiaPSbXc wherein —X represents at least one halogen element; —a represents a number from 3.0 to 6.0; —b represents a number from 3.5 to 5.0; and —c represents a number from 0 to 3.0.

### CROSS-REFERENCE TO RELATED APPLICATION

The present application claims priority filed on 7 Jul. 2021 in EUROPE with Nr 21315122.8, the whole content of this application being incorporated herein by reference for all purposes.

### TECHNICAL FIELD

The present disclosure relates to a process of obtaining a powder of lithium sulfide (Li₂S powder) having a d₅₀-value of less than 10 μm, a specific surface area of more than 5 m²/g, a total pore volume of more than 0.035 cm³/g and a percentage of total pore volume constituted of pore with diameter below 20 nm of more than 20%, comprising the steps of: a) providing a powder of lithium hydroxide having a d₅₀-value of less than 10 μm and presenting a residual water content below 5 wt. % (LiOH powder A), and b) reacting such LiOH powder A with a sulfide reactant, in order to obtain the Li₂S powder. The present disclosure also relates to the powder of lithium sulfide (Li₂S powder) obtained from such process and the use of such Li₂S powder to prepare a solid compound of formula (I):

LiₐPS_{b}X_{c} (I)
wherein
   X represents at least one halogen element;
   a represents a number from 3.0 to 6.0;
   b represents a number from 3.5 to 5.0; and
   c represents a number from 0 to 3.0.

### BACKGROUND

Lithium ion batteries are widely used as power supplies notably for appliances. In such secondary batteries, an organic solvent is used as an organic liquid electrolyte and lithium ions migrate from one electrode to the other, depending on whether the battery is charging or discharging.

Because the solvent used as an electrolyte is flammable, all-solid-state lithium ion battery not using organic solvent are very attractive. Such all-solid-state lithium ion batteries are formed by solidifying the whole battery using a solid electrolyte, for example containing Li, P, S, and a halogen.

One of the starting materials to prepare such solid electrolyte is lithium sulfide (Li₂S). The technical features (e.g. purity, particle size and porosity) of such starting material is crucial to obtain a high purity solid electrolyte. Different methods have been disclosed in the art for the manufacture of Li₂S.

For example, US 2020/165129 A1 (Albemarle) relates to a Li₂S powder and its preparation, such powder having an average particle size between 250 and 1,500 μm and BET surface areas between 1 and 100 m²/g. The preparation method consists in: a) heating lithium hydroxide monohydrate with an average particle size in the 150-2,000 μm range in a temperature-controlled unit to a reaction temperature between 150° C.-450° C. in the absence of air, flowing an inert gas over or through it, until the residual water of crystallization content of the formed lithium hydroxide is less than 5 wt. % and b) overflowing or traversing the anhydrous lithium hydroxide formed in the first stage by a sulfur source.

Such Li₂S powder however suffers from its high average particle size, over 100 μm, which implies further processing before use, especially if such Li₂S powder is to be used in the preparation of battery components.

US 2015/0246811 (Arkema France) discloses a method for preparing an alkali metal sulfide, which comprises at least one stage a) of reaction of at least one oxygen-comprising compound of said alkali metal with at least one sulfur-comprising compound of formula (I) R—S(═O)ₙ-Sx-R′. Two embodiments are disclosed for performing said stage a). A first embodiment is carried out at a temperature of between 150° C. and 500° C., preferably between 150° C. and 400° C., preferably between 200° C. and 350° C., in the presence of at least one catalyst, which has the aim of increasing the kinetics of the reaction. A second embodiment is carried out at a temperature preferably between 300° C. and 800° C., preferably between 300° C. and 600° C., optionally in the absence of catalyst. Under stage a), water is preferably added, or as an alternative to water, hydrogen can be used. In the examples, a preliminary stage is performed under nitrogen flow, at a temperature of 550° C. and 250° C. This process suffers from requiring a complex raw material (R—S(═O)ₙ-Sx-R′) and the use of a catalyst or of high reaction temperatures.

Ohsaki et al. (Powder Technology, 387, July 2021, 415-420) describe the synthesis of solid electrolyte particles of Li₃PS₄ with controlling size in the submicron order using a liquid-phase shaking method, starting from fine Li₂S particles, which have to be processed through wet milling or dissolution-precipitation processes before being used for the preparation of solid electrolyte particles of Li₃PS₄.

US 2016/0104916 (Idemitsu Kosan Co., Ltd.) discloses a method for producing a solid electrolyte, including bringing an alkali metal sulfide, one or two or more sulfur compounds and a halogen compound into contact with each other in a solvent. The preparation of the alkali metal sulfide, in particular of Li₂S, is disclosed by reference to methods known from the prior art. For example, the reaction of lithium hydroxide and hydrogen sulfide in a hydrocarbon-based solvent at 70° C. to 300° C. is disclosed. Lithium sulfide can be modified by using a solvent including a polar solvent, so that a large specific surface area is obtained. Toluene is used in Production Example 1. The particle size of the alkali metal sulfides used as a raw material is not limited, indeed particle size can exceed 100 micrometers as the step of reducing the particle size is not always advantageous in terms of costs.

An anode material and a method for its preparation is also disclosed in US 201310295464 (Idemitsu Kosan Co., Ltd.). As the raw materials, hydrogen sulfide and an alkali metal hydroxide can be used. Production example 1 discloses the reaction between lithium hydroxide and hydrogen sulfide, in N-methyl-2-pyrrolidone (NMP) at 130° C.

### SUMMARY

The Applicant is aware that Li₂S suffers from low cycling stability, low-rate capability and high initial activation potential.

In addition, the Applicant noticed that the commercially available Li₂S is of high cost and of large particle size, over 10 μm, which exacerbate its shortcomings as a battery component.

Hence, the Applicant faced the problem of providing a new process for the manufacture of Li₂S powder.

More in particular, the Applicant faced the problem of providing a process for the manufacture of small-sized Li₂S particles, which can remain uniformly dispersed.

The present invention relates to a process of obtaining a powder of lithium sulfide (Li₂S powder) having a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction), comprising the steps of:
a) providing a powder of lithium hydroxide having a d₅₀-value of less than 10 μm and presenting a residual water content below 5 wt. % (LiOH powder A),
b) reacting such LiOH powder A with a sulfide reactant, in order to obtain the Li₂S powder,
wherein the LiOH powder A is obtained by:
   a step of grinding a powder of lithium hydroxide monohydrate (LiOH·H₂O) having a d₅₀-value of more than 10 μm (LiOH powder B), in order to obtain a powder of lithium hydroxide monohydrate (LiOH·H₂O) having a d₅₀-value of less than 10 μm (LiOH powder C) and a step of heating such LiOH powder C at a temperature of less than 180° C., in order to obtain the LiOH powder A; or
   a step of heating a powder of lithium hydroxide monohydrate (LiOH·H₂O) presenting a residual water content above 5 wt. %, at a temperature of less than 180° C., in order to obtain a powder of lithium hydroxide presenting a residual water content below 5 wt. % (LiOH powder D) and a step of grinding such LiOH powder D, in order to obtain the LiOH powder A.

The present invention also relates to a powder of lithium sulfide (Li₂S powder) having a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction).

The present invention also relates to a process for preparing a solid compound of formula (I):

LiₐPS_{b}X_{c} (I)

wherein
X represents at least one halogen element;
a represents a number from 3.0 to 6.0;
b represents a number from 3.5 to 5.0; and
c represents a number from 0 to 3.0,
said process comprising the use of the Li₂S powder disclosed above

The present invention also relates to a compound of formula (I), in particular Li₆PS₅Cl or Li₃PS₄, obtainable by the method described herein.

### DISCLOSURE OF THE INVENTION

In the present application:
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

The present invention relates to a process for obtaining a powder of lithium sulfide powder (Li₂S powder), such powder having certain specific technical features which makes it well-suited to be used to prepare battery components such as lithium sulfide electrolyte, including lithium argyrodites.

The process of the present invention for the manufacture of said Li₂S powder advantageously comprises at least the steps of:
a) providing a powder of lithium hydroxide having a d₅₀-value of less than 10 μm and presenting a residual water content below 5 wt. % (LiOH powder A),
b) reacting such LiOH powder A with a sulfide reactant, in order to obtain the Li₂S powder.

Advantageously, the process of the present invention is solvent and/or diluent free. In other words, no solvent and/or diluent is added to the reaction vessel during the reaction under step b). This is advantageous because the step for removing the solvent adds to the complexity of the industrial process, as well as to its overall cost.

It is understood that the process according to the present invention may be carried out in the presence of a very low amount of solvent, that-is-to-say an amount of solvent less than 5 wt. %, based on the total weight of the reaction mixture. Preferably, according to this embodiment, the amount of solvent is less than 4 wt. %, less than 3 wt. %, less than 2 wt. %, less than 1 wt. %, less than 0.5 wt. %, less than 0.1 wt. %, less than 0.01 wt. %, or less than 0.001 wt. % of solvent, based on the total weight of the reaction mixture. The total weight of the reaction mixture is obtained by adding the weight of the reactants.

In addition and advantageously, no catalyst is added in the process of the present invention. The term “catalyst” as used in the present description and in the following claims is intended to indicate any compound capable of increasing the kinetic of the reaction under step b). For example, said catalyst can be selected from cobalt oxides, nickel oxides, molybdenum oxides and mixtures thereof, which can be supported or not supported for example on silica, alumina or active charcoal.

The process of the present invention comprises at least two steps:
a) providing a powder of lithium hydroxide having a d₅₀-value of less than 10 μm and presenting a residual water content below 5 wt. % (LiOH powder A), and
b) reacting such LiOH powder A with a sulfide reactant, in order to obtain the Li₂S powder,

wherein the LiOH powder A is prepared by a combination of at least two steps: a step of grinding and a step of heating at a temperature of less than 180° C.

These two steps of grinding and of heating can take place in any order grinding then heating or heating then grinding.

One of the key difference of the process of the present invention is that the particle size of the powder of lithium hydroxide is reduced before the implementation of step b) of reacting it with a sulfide reactant.

One of the other key difference is that the powder of lithium hydroxide is heated at a low temperature, in comparison and contrary to the processes described in the prior art, according to which if drying takes place at low temperature, the resulting LiOH will be less reactive towards the sulfide source.

The process of the present invention is advantageous in this respect, as the heating step takes place at a temperature of 180° C. or less, which reduces the overall process cost. The inventors have indeed realized that contrary to the opinion that the LiOH powder should be heated to high temperatures above 200° C. in order to be reactive towards sulfur, heating the powder of lithium hydroxide at a temperature below 180° C. leads to a Li₂S powder with an advantageous set of properties, including pore volumes, to prepare a high quality solid compound (1) of formula LiₐPS_{b}X_{c}.

Without being bound by any theory, this advantageous set of properties is due to the combination of the heating and grinding steps to prepare the powder of lithium hydroxide before being used in the Li₂S process. Under said two steps, the powder of lithium hydroxide is reduced in size and presents a specific agglomeration level, as determined by the measure of its pore volume. Using low temperatures is not only advantageous from a cost-control perspective, but it also makes possible the manufacture of a Li₂S powder well suited to be used in the preparation of a solid electrolyte.

Preferably, step a) of the process of the present invention consists in providing a LiOH powder A having a d₅₀-value of less than 10 μm and presenting a residual water content below 5 wt. %.

In some embodiments, the d₅₀-value of the LiOH powder is less than 10 μm, less than 8 μm, less than 6 μm, less than 4 μm or even less than 2 μm. In some embodiments, the d₅₀-value of the LiOH powder is at least 100 nm, at least 200 nm, or even at least 300 nm.

In some embodiments, the residual water content of the LiOH powder A is less than 4 wt. %, less than 3 wt. %, less than 2 wt. %, less than 1 wt. % or even less than 0.1 wt. % based on the total weight of the LiOH powder. In some embodiments, the residual water content of the LiOH powder A is more than 0.001 wt. %, or more than 0.01 wt. %.

The LiOH powder A of step a) may be obtained by two alternative embodiments.

According to a first embodiment, the LiOH powder A is prepared by a combination of at least the following two steps:
1/ a step of grinding a powder of lithium hydroxide monohydrate (LiOH·H₂O) having a d₅₀-value of more than 10 μm (LiOH powder B), in order to obtain a powder of lithium hydroxide monohydrate (LiOH·H₂O) having a d₅₀-value of less than 10 μm (LiOH powder C) and
2/ a step of heating such LiOH powder C at a temperature of less than 180° C., in order to obtain the LiOH powder A.

According to a second embodiment, the LiOH powder A is prepared by a combination of at least the following two steps:
1′/ a step of heating a powder of lithium hydroxide monohydrate (LiOH·H₂O) presenting a residual water content above 5 wt. %, at a temperature of less than 180° C., in order to obtain a powder of lithium hydroxide presenting a residual water content below 5 wt. % (LiOH powder D) and
2/ a step of grinding such LiOH powder D, in order to obtain the LiOH powder A.

According to these two embodiments, the step of heating is performed at a temperature of less than 180° C. Such temperature may for example be less than 170° C., less than 160° C., less than 150° C., less than 140° C., less than 130° C., less than 120° C., less than 110° C. and even less than 100° C. The heating step can for example take place at a temperature of 80° C.

Preferably, such heating step is performed in the absence of air. The heating step advantageously takes place under vacuum and/or by flowing an inert gas over or through the powder.

The time duration of the heating step is not limited and can be as long as needed to reach the expected residual amount of water. For example, the heating step can last between 1 and 24 hours.

According to these two embodiments, the step of grinding is performed so that a powder is obtained with a d₅₀-value of less than 10 μm.

Any type of equipment can be used to perform such grinding. Reference can for example be made to rotor-stator grinders, planetary ball mills or attritors.

The time duration of the grinding step is not limited and can be as long as needed to reach the expected d₅₀-value. For example, the grinding step can last between 1 and 24 hours.

Preferably, the second step b) of the process consists in reacting such LiOH powder A with a sulfide reactant, in order to obtain the Li₂S powder.

Step b) preferably takes place at a temperature varying from 100 to 260° C., for example varying from 110 and 250° C., or between 12° and 240° C.

The sulfide reactant may be selected from the group consisting of hydrogen sulfide, elemental sulfur, carbon disulfide, mercaptans, sulfur nitrides, organic sulfides and organic disulfides. Hydrogen sulfide is preferred and gaseous hydrogen sulfide (H₂S) is more preferred.

The reaction takes place in a container allowing LiOH powder to be in contact with a sulfide reactant, for example H₂S gas. The reaction container preferably includes a stirring blade. The reactor may be a vertical vessel in which the reactants are positioned at the bottom of the reactor. Other types of reactors may also be used, for example lateral reactor such as dryers or extruders. The reactor is preferably sealed. The capacity of the reactor is not limited. The reaction may takes place at a pressure under or above atmospheric pressure, for example a pressure of 0.05 MPa or a pressure of 1 MPa can be used. The reactor is equipped with at least one heating mean. The heating mean keeps the temperature of an inner wall of the reactor in contact with the raw materials. The reactor may be equipped with additional heating means, for example a second heating mean, which may be located at the upper part of the reactor. The reactor is also equipped with means to inject the sulfide reactant, for example the gaseous H₂S.

Step b) preferably takes place while stirring the LiOH powder A. In this case, the container is equipped with a stirring blade or a conveying stirrer which is positioned as close as possible to the bottom of the reactor and/or as close as possible to the walls, for example with a d/D>0.9 (d is the size of the stirring blade and D is the internal diameter of the container).

Water is preferably removed during step b). This can be achieved by placing a condenser on the gas discharge line of the container, where water that is in the gaseous state becomes liquid (condensed) and collected outside of the container.

The process of the present invention may be continuous or it may be batch-wise.

The present invention also relates to Li₂S powder characterized in that it has a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction).

Such Li₂S powder may notably be produced by the process of the present invention.

The inventors have been able to identify a combination of raw materials and steps leading to a Li₂S powder which is ready to be used directly in a process for preparing a solid compound of formula LiₐPS_{b}X_{c} (I), without additional processing steps (e.g. grinding).

Surprisingly, the Li₂S powder obtained from the process according to the present invention is characterized by a degree of agglomeration, which makes it well-suited for the preparation of a solid compound of formula LiₐPS_{b}X_{c} to be used as a next generation battery component.

In the context of the present invention, the agglomerated particles are characterized by their pore volume and the term “agglomerated particles” is intended to mean bonded divided particles that are organized into larger, mechanically strong particles. More precisely, such degree of agglomeration of the particles is characterized by a measure of the specific surface area, as measured by nitrogen gas adsorption according to Brunauer-Emmet-Teller (BET) method, the total pore volume and the percentage of total pore volume constituted of pore with diameter below 20 nm, both measured by nitrogen gas adsorption according to Harkins and Jura method of the BJH model, with FAAS correction.

The Li₂S powder of the present invention is characterized by its d₅₀-value, as measured by laser diffraction in para-xylene. According to the invention, the d₅₀-value of the Li₂S powder is less than 10 μm, less than 8 μm, less than 6 μm, less than 4 μm or even less than 2 μm. In some embodiments, the d₅₀-value of the Li₂S powder is at least 100 nm, at least 200 nm, or even at least 300 nm.

The Li₂S powder of the present invention is characterized by its high specific surface area, as measured by nitrogen gas adsorption according to Brunauer-Emmet-Teller (BET) method. According to the invention, the specific surface area of the Li₂S powder is of more than 5.0 m²/g, more than 5.5 m²/g, more than 6.0 m²/g, more than 6.5 m²/g or even more than 6.9 m²/g. In some embodiments, the specific surface area of the Li₂S powder is less than 40 m²/g, less than 35 m²/g or even less than 30 m²/g.

The Li₂S powder of the present invention is characterized by a high total pore volume. According to the invention, the total pore volume of the Li₂S powder is of more than 0.035 cm³/g, more than 0.039 cm³/g, more than 0.042 cm³/g, more than 0.045 cm³/g or even more than 0.049 cm³/g. In some embodiments, the total pore volume of the Li₂S powder is less than 1.0 cm³/g, less than 0.80 cm³/g or even less than 0.50 cm³/g.

The Li₂S powder of the present invention is characterized by a high pore distribution. According to the invention, the pore distribution of the Li₂S powder is such that the pore volume from pores with diameter below 20 nm is at least 20%, at least 30%, at least 35%, at least 40%, or even at least 45%. In some embodiments, such pore distribution is less than 100%, less than 99% or even less than 98%.

The Li₂S powder of the present invention may also be characterized by any one or several of the following features:
a d₁₀-value higher than 0.05 μm, as measured by laser diffraction in para-xylene, for example a d₁₀-value higher than 0.07 μm, higher than 0.09 μm, or higher than 0.1 μm;
a d₉₀-value of less than 50 μm, as measured by laser diffraction in para-xylene, for example a d₁₀-value of less than 40 μm, less than 30 μm, less than 20 μm or less than 15 μm.

The present invention thus features novel Li₂S particles in the form of particles or powders, characterized by their size and degree of agglomeration, which may be substantially spheroidal. Such Li₂S particles present a notable capacity for dispersion and deagglomeration when being engaged into further reaction, for example the preparation of solid compound (I) of formula LiₐPS_{b}X_{c}. This is advantageous because the particles of solid compound (I), manufactured from the Li₂S powder according to the present invention, do not need to be milled before being used in a battery formulation, as this would potentially lead to a decrease in their conductivity.

An aspect of the present invention is also directed to a process for preparing a solid compound of formula (I):

LiₐPS_{b}X_{c} (I)
wherein
   X represents at least one halogen element;
   a represents a number from 3.0 to 6.0;
   b represents a number from 3.5 to 5.0; and
   c represents a number from 0 to 3.0,

said process comprising the use of a lithium sulfide powder of the present invention.

For the sake of clarity, a, b and c numbers can be integers or non-integers/decimals and the endpoints of the range and equivalents are included in the scope.

In some embodiments, such process comprises the steps of:
mixing the starting material (the powder of lithium hydroxide, the sulfide reactant, phosphor containing material and halogen containing material), in dry or slurry state, optionally applying mechanical energy, including the lithium sulfide powder of the present invention, to provide a mixture;
optionally drying said mixture,
optionally pressing the resulting dried mixture into pellets, and
heating the mixture, optionally dried, or the pellets to a temperature comprised between 350° C. and 550° C. for a time period of at least 2 hours, for example 4 hours, 6 hours, 8 hours, 10 hours or 12 hours.

In some embodiments, such process comprises at least one step for the preparation of a solution S1 at a temperature T1 comprised from −200° C. to 10° C., said solution S1 comprising a solvent and at least P species under the form of (PS₄)³⁻, Li species under the form of Li⁺, X species under the form of X⁻ and remaining sulfur under the form of lithium sulfide powder of the present invention,

followed by a step for removing at least a portion of the solvent from said solution S1 to obtain LiₐPS_{b}X_{c}.

According to these embodiments, the solution S1 may be obtained by admixing lithium sulfide according to the present invention, phosphorus sulfide, and a halogen compound in the solvent, at a temperature comprised from −200° C. to 10° C., preferably from −110° C. to −10° C., in particular from −100° C. to −50° C.

Alternatively, the solution S1 can be obtained from the following steps:
1/ obtaining a precursor solution by admixing lithium sulfide according to the present invention and a halogen compound in the solvent; and
2/ adding phosphorus sulfide into said precursor solution at a temperature comprised from −200° C. to 10° C.; in order to obtain said solution S1.

The step for removing at least a portion of the solvent from S1 may be carried out at a temperature comprised from 30° C. to 200° C. The preparation of the solution S1 occurs in an inert atmosphere, under vacuum or under H₂S flow.

The so-obtained LiₐPS_{b}X_{c} may then thermally treated at a temperature comprised from 150° C. to 700° C.

The solvent used in such process is preferably able to dissolve LiₐPS_{b}X_{c}, lithium sulfide, phosphorus sulfide and a halogen compound. It may be an aliphatic alcohol, for example chosen from the group consisting of ethanol, methanol, and mixtures thereof.

The halogen compound is preferably chosen from the group consisting of LiCl, LiBr, LiI, and LiF.

The solution S1 may comprise at least 50 mol. % of Li species under the form of Li⁺, with respect to the total amount in moles of lithium sulfide added in the solvent, preferably at least 80 mol. % of Li species under the form of Li⁺, more preferably at least 95 mol. % of Li species under the form of Li⁺.

The solution S1 may comprise at least 50 mol. % of P species under the form of (PS₄)³⁻, with respect to the total amount in moles of phosphorus sulfide added in the solvent, preferably at least 80 mol. % of P species under the form of (PS₄)³⁻, more preferably at least 95 mol. % of P species under the form of (PS₄)³⁻.

The solution S1 may comprise at least 50 mol. % of X species under the form of X⁻, with respect to the total amount in moles of halogen compound added in the solvent, preferably at least 80 mol. % of X species under the form of X⁻, more preferably at least 95 mol. % of X species under the form of X⁻.

The present invention also relates to a compound of formula LiₐPS_{b}X_{c} (I) wherein
X represents at least one halogen element;
a represents a number from 3.0 to 6.0;
b represents a number from 3.5 to 5.0; and
c represents a number from 0 to 3.0,

obtainable by the method descried herein.

The present invention finally relates to:
a Li₆PS₅X, wherein X is halogen, obtainable by the method described herein,
a Li₃PS₄ obtainable by the method described herein,
the use of such LiₐPS_{b}X_{c}, for example Li₆PS₅X and Li₃PS₄ described herein, as a solid electrolyte,
a solid electrolyte comprising such LiₐPS_{b}X_{c}, for example Li₆PS₅X and Li₃PS₄ described herein,
an electrochemical device comprising LiₐPS_{b}X_{c}, for example Li₆PS₅X and Li₃PS₄ described herein,
a solid state battery comprising a solid electrolyte described herein, and
a vehicle comprising a solid state battery described herein.

Should the disclosure of any patents, patent applications, and publications which are incorporated herein by reference conflict with the description of the present application to the extent that it may render a term unclear, the present description shall take precedence.

1. A process of obtaining a powder of lithium sulfide (Li₂S powder) having a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction), comprising the steps of:
a) providing a powder of lithium hydroxide having a d₅₀-value of less than 10 μm and presenting a residual water content below 5 wt. % (LiOH powder A),
b) reacting such LiOH powder A with a sulfide reactant, in order to obtain the Li₂S powder,
wherein the LiOH powder A is obtained by:
a step of grinding a powder of lithium hydroxide monohydrate (LiOH·H₂O) having a d₅₀-value of more than 10 μm (LiOH powder B), in order to obtain a powder of lithium hydroxide monohydrate (LiOH·H₂O) having a d₅₀-value of less than 10 μm (LiOH powder C) and a step of heating such LiOH powder C at a temperature of less than 180° C., in order to obtain the LiOH powder A or
a step of heating a powder of lithium hydroxide monohydrate (LiOH·H₂O) presenting a residual water content above 5 wt. %, at a temperature of less than 180° C., in order to obtain a powder of lithium hydroxide presenting a residual water content below 5 wt. % (LiOH powder D) and a step of grinding such LiOH powder D, in order to obtain the LiOH powder A.

2. The process of claim 1, wherein the step of heating is performed at a temperature of less than 170° C.

3. The process of claim 1, wherein no solvent and/or diluent and/or catalyst is added to the reaction vessel during the reaction under step b).

4. The process of claim 1, wherein the sulfide reactant used in step b) is gaseous hydrogen sulfide (H₂S).

5. The process of claim 1, wherein step b) takes place:
at a temperature varying from 100° C. to 260° C., in a reactor equipped with at least one heating mean; and/or
while stirring the LiOH powder A, in a reactor equipped with a stirring blade or a conveying stirrer which is positioned as close as possible to the bottom of the reactor and/or as close as possible to the walls; and/or
by removing water.

6. The process of claim 1, wherein the Li₂S powder is such that it has:
a d₁₀-value higher than 0.05 μm and/or
a d₉₀-value of less than 50 μm,
as measured by laser diffraction in para-xylene.

7. A process of obtaining a powder of lithium hydroxide having a d₅₀-value of less than 10 μm (as measured by laser diffraction in para-xylene) comprising grinding a lithium hydroxide powder having a d₅₀-value of more than 10 μm, such lithium hydroxide powder presenting a residual water content below 5 wt. %.

8. A lithium sulfide powder (Li₂S powder) having a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction).

9. The powder of claim 8, having:
a d₁₀-value higher than 0.05 μm, as measured by laser diffraction in para-xylene, and/or
a d₉₀-value of less than 50 μm, as measured by laser diffraction in para-xylene.

10. A lithium sulfide powder obtainable by the process of claim 1, the lithium sulfide powder having a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction).

11. A process for preparing a solid compound of formula (I):
LiₐPS_{b}X_{c} (I)
wherein
X represents at least one halogen element;
a represents a number from 3.0 to 6.0;
b represents a number from 3.5 to 5.0; and
c represents a number from 0 to 3.0,
said process comprising the steps of
mixing the starting materials, in dry or slurry state, including the lithium sulfide powder of claim 8, to provide a mixture,
optionally drying said mixture,
optionally pressing the resulting dried mixture into pellets, and
heating the mixture, optionally dried, or the pellets to a temperature comprised between 350° C. and 550° C. for a time period of at least 2 hours.

12. The process of claim 11, comprising at least one step for the preparation of a solution S1 at a temperature T1 comprised from −200° C. to 10° C., said solution S1 comprising a solvent and at least P species under the form of (PS₄)³⁻, Li species under the form of Li⁺, X species under the form of X⁻ and remaining sulfur under the form of lithium sulfide powder, the lithium sulfide powder having a d₅₀-value of less than 10 μm (as measured by laser diffraction in para-xylene), a specific surface area of more than 5 m²/g (as measured by nitrogen gas adsorption according to Brunauer-Emmet-Teller (BET) method), a total pore volume of more than 0.035 cm³/g (as measured by nitrogen gas adsorption according to Harkins and Jura method of the BJH model, with FAAS correction) and a percentage of total pore volume constituted of pore with diameter below 20 nm of more than 20% (as measured by nitrogen gas adsorption according to Harkins and Jura method of the BJH model, with FAAS correction), followed by a step for removing at least a portion of the solvent from said solution S1 to obtain LiₐPS_{b}X_{c}.

13. A method comprising preparing a solid compound with the lithium sulfide powder of claim 8, the solid compound of formula (I):
LiₐPS_{b}X_{c} (I)
wherein
X represents at least one halogen element;
a represents a number from 3.0 to 6.0;
b represents a number from 3.5 to 5.0; and
c represents a number from 0 to 3.0.

14. The method of claim 13, wherein compound (I) is Li₆PS₅Cl or Li₃PS₄.
